(19) United States
(12) Patent Application Publication
(10) Pub. No.: US 2010/0294969 A1
(43) Pub. Date: Nov. 25, 2010

(54) IN-LINE LIQUID VALVE CONTROLLED BY AN EXPANDING AND CONTRACTING HYGROSCOPIC MATERIAL

(76) Inventor: Stephen McGuiness, Queensland (AU)

Correspondence Address: Martin P Hoffman;Hoffman Wasson & Gitler, 2461 South Clark Street, Suite 522, Arlington, VA, 22202, US

(21) Appl. No.: 12/452,497

(22) PCT Filed: Jul. 4, 2008
(86) PCT No.: PCT/AU2008/000988

§ 371 Date: Aug. 2, 2010

(30) Foreign Application Priority Data
Jul. 5, 2007 (AU) 2007903642

(51) Int. Cl. F16K 1/00; F16K 25/00

(52) U.S. Cl. 251/319; 251/368

(57) ABSTRACT

An in-line valve is disclosed or for closing or restricting flow through a liquid conduit or an opening in a liquid containment vessel when the valve is closed, the valve having a valve seat associated with the liquid conduit or the opening in the liquid containment vessel, a valve member that can move between an open position in which it does not engage with the seat and a closed position in which it engages with the seat to close the valve, and a hygroscopic material that can move the valve member between the open and closed positions, wherein when the valve member is in the open position liquid is able to pass freely through the valve but as the liquid passes through the valve the hygroscopic material absorbs liquid directly from the flow through the valve causing the hygroscopic material to swell and thereby move the valve member into the closed position restricting flow through the liquid conduit or the opening in the liquid containment vessel.

### FIELD OF THE INVENTION

The present invention relates to valves used to at least partially close off, limit or restrict flow through liquid flow conduits or openings in liquid containment vessels. For convenience, the invention will be described primarily with reference to applications involving or associated with the collection of rainwater, for example from the roofs of buildings. However, those skilled in the art will recognize that the valve of the present invention is capable of use in a range of other applications, and that those applications fall within the scope of the invention as well.

### BACKGROUND

Rainwater is often collected off the roofs of houses and other buildings to be stored in rainwater tanks. In order to minimise the amount of contaminants entering the tank with the flow of rainwater, devices called “first flush diverters” are commonly used. First flush diverters operate on the basis that contaminants become deposited on the roof of a building during dry periods between episodes of rainfall. As a result, the water collected from the roof during the initial period of rainfall immediately after a dry spell contains a high concentration of contaminants. However, this initial period of rainfall effectively flushes the roof off and so, as it continues to rain, water collected from the roof after the initial period of rainfall is comparatively clean. Consequently, first flush diverters operate to divert the volume of water that runs off the roof during the initial period of rainfall (i.e. the initial flush of water containing the higher concentration of contaminants) away from the tank. The comparatively clean water that is collected from the roof after the initial period of rainfall is then directed into the tank for storage.

One of the main problems associated with current first flush diverters is that they are often bulky units installed at or near the entry to the rainwater storage tank. First flush diverters also often involve a number of parts with a complex interaction, making them difficult to maintain and repair. There would therefore be an advantage if a simpler means could be provided for diverting the initial contaminated flush of water away from the tank and then redirecting the subsequent flow of water into the tank for storage.

In order to collect the rainwater that falls on the roof of a building, the roof will generally be provided with an open topped channel-like guttering which extends around the perimeter of the roof to catch the water that runs off the roof. The guttering will typically be provided with more than one (typically several) downpipes which open through the base of the guttering to allow the water collected in the guttering to escape. The multiple respective downpipes are typically located at spaced locations around the perimeter of the roof. Providing multiple downpipes has the advantage that, even if one downpipe becomes blocked, the water can still escape through one or more of the other downpipes. However, very often, buildings will only have a single rainwater tank for storing the rainwater collected off the roof. Therefore, typically only one or some of the downpipes feed into the tank. Others of the downpipes (for example downpipes on the opposite side of the building to the tank) may lead directly to sewer etc. Consequently, water escaping through those downpipes (i.e. the downpipes which do not lead to the tank) is not collected in the tank. It is simply lost. In some instances, water collected from entire sections of the roof can be lost in this way. Therefore, there would appear to be an advantage if means could be provided for directing the water to exit the guttering through the downpipes that lead to the tank in order to maximise the amount of water collected.

It is an object of the present invention to provide a valve, one use for which may be to help address the above-mentioned issues, or which may at least provide a useful or commercial alternative to other valves in the marketplace.

The invention makes use of hygroscopic material. As explained below, hygroscopic materials are materials which can take up water/moisture through absorption or adsorption. In the past, hygroscopic materials have found use in automated or semi-automated systems for watering plants or maintaining desired moisture levels in soils for growing planets, crops and the like. Some examples of the way hygroscopic materials have been used in this way are given in Australian Patent Application No 1984/27242, U.S. Pat. No. 4,696,319, Swiss Patent No 568513 and International Patent Application No PCT/AU96/00002. In each of these documents, some form of sensor or component is provided which includes a hygroscopic element in close proximity or contact with the environment or growth medium (typically the soil used for growing the planets/crops). In general, when the soil/growth medium/environment contains less moisture than the hygroscopic element, the element contracts and this triggers the system to introduce more water or moisture. Then, when the level of water/moisture in the soil/growth medium/environment rises, water/moisture is absorbed by the hygroscopic element causing the system to cease the supply of water/moisture. Hence, an aspect which is common to each of these arrangements is that the hygroscopic element operates to absorb water/moisture from the surrounding environment/soil.

Another example of a previous use of hygroscopic materials is given in U.S. patent application Ser. No. 10/956,354. This document also relates to an apparatus used in soil/agricultural irrigation, and like the arrangements discussed in the previous paragraph, the delivery of irrigation fluid is curtailed and allowed respectively by absorption and dispersion of moisture by/from the hygroscopic material. Unlike the arrangements discussed in the previous paragraph though, the hygroscopic material in this document does not absorb moisture directly from the surrounding environment. Rather, the fluid absorbed by, and dispersed from, the hygroscopic material is extracted from the main fluid delivery tube by a subsidiary bypass tube. Hence, the arrangement in this document uses fluid taken from the main delivery tube to control the rate of flow through that main delivery tube. In other words, the hygroscopically operated fluid flow rate control device in this document operates from outside and is separate from the main flow of fluid in the primary delivery tube.

It will be clearly understood that any reference herein to background products or material, prior publications or technical problems does not constitute an acknowledgement or admission that any background material, prior publication(s), technical problem(s) or combination(s) thereof formed part of the common general knowledge in the field or is otherwise admissible prior art, whether in Australia or any other country.

### DESCRIPTION OF THE INVENTION

In a first aspect, the present invention provides an in-line valve for closing or restricting flow through a liquid conduit or an opening in a liquid containment vessel when the valve is closed. The valve has a valve seat associated with the liquid conduit or the opening in the liquid containment vessel, a valve member that can move between an open position in which it does not engage with the seat and a closed position in which it engages with the seat to close the valve, and a hygroscopic material that can move the valve member between the open and closed positions. When the valve member is in the open position liquid is able to pass freely through the valve. However, in some embodiments, as the liquid passes through the valve the hygroscopic material absorbs liquid causing the hygroscopic material to swell and thereby move the valve member into the closed position restricting flow of liquid through the opening. When flow through the liquid conduit or the opening in the vessel ceases for a period of time, the hygroscopic material dries out and contracts thereby enabling the valve member to move back into the open position wherein liquid can flow freely through the valve. In other embodiments, the valve may be closed when the hygroscopic material is dry, and wetting the material (making it swell) may open the valve.

As indicated above, the valve of the present invention will be described primarily with reference to applications where the valve is used to close off and thereby prevent or restrict the flow of water through rainwater conduits or openings in water containment vessels. Therefore, the valve might be used to close off or constrict flow in rainwater pipes, or in openings such as downpipes in roof gutterings, or openings in water tanks etc. However, those skilled in the art will recognize that the valve of the present invention is able to be used in other applications as well. For example, the valve might find use in closing grey water conduits or openings in grey water tanks, or in applications involving liquids other than water. Even though the invention is described with reference to rainwater conduits/vessels, the features which make the invention applicable in other areas will be evident to those skilled in the art, and use of the valve in other areas is contemplated and falls within the scope of the invention.

One of the important aspects of the invention is that the valve is an “in-line” valve. In other words, the valve is positioned inside the rainwater conduit or inside the opening in the vessel, and the flow of water through the conduit/opening is what operates hygroscopic material to open/close the valve. Hence, the hygroscopic material is operated directly by the flow of water through the valve. This is fundamentally different to the arrangements disclosed in the prior art documents discussed above. Many of the above-mentioned prior art arrangements operated by taking water/moisture from the outside environment, and even U.S. patent application Ser. No. 10/956,354 (which operated to control the flow of fluid through the main flow tube) did so from externally of the main flow tube. One of the major benefits achieved by the “in-line” nature of the present valve (i.e. by placing the valve inside the conduit/opening) is that the construction and operation of the valve can be significantly simplified in comparison.

The in-line valve of the present invention operates to restrict the flow of water through a water conduit or an opening in a water vessel. In some embodiments, the valve may operate to prevent substantially any flow of water through the valve when the valve is closed. In other embodiments, when the valve is closed, the flow of water may be limited, or restricted to flow in a particular way, but not stopped entirely. When the valve is open, the water may pass freely through the valve.

The valve has a valve seat associated with the water conduit or vessel opening. The valve seat should itself have a passageway (or a number of passageways) extending all the way through so that water can flow freely through the valve seat (and hence through the valve) when the valve is open. In some versions of the valve, the valve seat may comprise nothing more than a ridge or some similar feature in the conduit or an edge or rim of the opening in the vessel. In other words, the valve seat need not comprise a separate component from the conduit/vessel. However, in other embodiments the valve seat may comprise a separate component (or components). The seat (whether a separate component or not) may be shaped so as to engage with the valve member as described further below.

Where the valve seat comprises a separate component (or components) from the conduit/vessel, the seat may incorporate means for securing the seat in the conduit/vessel. This means may also secure the entire valve in position. Any suitable means for securing the seat may be used. For example, the seat may be provided with a rim or tabs etc that overlap with the edge(s) of an opening in a vessel so that the valve seat can be secured in the opening by inserting mechanical fasteners through the overlapping portions, or by using adhesives or suitable sealants between the overlapping portions. Other means for securing the seat might also be used, such as press fits, twist lock or screw in arrangements. Preferably, the valve seat may be secured in such a way that liquid is prevented from flowing through the liquid flow conduit or the opening in the vessel otherwise than through the passageway(s) in the valve seat. For example, any spaces between the outside edge of the seat and an opening in a vessel should be sealed to prevent liquid from exiting through those spaces rather than through the valve. Sealants suitable for this purpose will be well-known to those skilled in the art.

The valve seat is associated with the conduit or vessel opening. However, this does not mean that, where the valve seat comprises a separate component (or components) from the opening in a vessel, the valve seat must be positioned directly in the opening. For example, where the valve is used to close off a downpipe that extends down from the bottom of a roof guttering, the valve might be installed part way down inside the downpipe rather than at the top of the downpipe where the downpipe connects to the opening in the guttering. Hence, the valve can be positioned inside a liquid flow conduit. Of course, the valve seat could alternatively be installed at the top of the downpipe in the opening in the guttering. In any event, this example demonstrates that the valve seat need not be installed directly in an opening. However, the valve should usually be configured such that, when installed, liquid cannot flow out through the opening in the vessel or through the conduit without also flowing through the valve. For example, liquid should generally be prevented from flowing through gaps around the outside of the valve (unless such gaps exist intentionally to allow flow when the valve is closed or partly closed).

The valve has a valve member that can move between an open position and a closed position. In the open position, the valve member does not engage with the valve seat, meaning that the valve is open and liquid can flow freely through the passage(s) in the valve seat and hence through the valve. Conversely, in the closed position, the valve member engages with the valve seat to close the valve and thereby limit the flow of liquid through the valve, or restrict the liquid to flow in a particular way. The valve member may take a wide range of shapes and configurations, as discussed below.

As explained above, some versions of the valve may prevent substantially any flow of water through the valve when the valve is closed. In these embodiments, the valve member should engage with the valve seat to create a seal sufficient to prevent substantially any flow in between the seat and the valve member. In some preferred embodiments, the open passage through the valve seat may have a circular rim. The valve member may therefore be shaped to engage closely with this circular rim. In particularly preferred embodiments, the valve member may comprise a ball with a smooth unbroken surface and a diameter that is considerably larger than that of the circular rim (hence the valve in these embodiments is a form of ball valve). When the ball-shaped valve member is moved into the closed position, the smooth curved surface of the ball may engage closely against the circular rim of the seat. Furthermore, the more firmly the ball is pressed against the circular rim (i.e. the more force that is applied to try and force the larger ball through the smaller circular rim), the greater the sealing engagement. Other “circular-type” shapes where the maximum diameter is greater than that of the circular rim might alternatively be used to similar effect. For example, the valve member might be shaped like a cone or a truncated cone where the wide end of the cone is larger in diameter than the circular rim. The cone might be oriented with its converging end extending towards or into the passageway in the seat. In order to close the valve, the cone shaped valve member could be moved so that its converging end moves further into or though the passageway so that the sloping sides of the cone come into sealing contact with the circular rim. Again, the more firmly the cone is pressed against the circular rim (i.e. the more force that is applied to try and force the larger wedge-like cone through the smaller circular rim), the greater the sealing engagement.

Importantly, whilst the preferred embodiments described in the previous paragraph have a “circular-type” shaped valve member that engages with a circular rim on the valve seat, other non-circular shapes may also be used. For example, the valve seat might define a rectangular rim and the valve member might be generally block shaped to enable it to engage sealingly with the rectangular rim. Furthermore, the valve member might have a shape that is unrelated to the shape of the valve seat's rim, but it may nevertheless have a portion which can extend over or cover the passageway through the seat to restrict the flow of water.

Also, it will be recalled that other embodiments of the invention operate to merely limit the flow of water through the valve when the valve is closed, or to restrict the liquid to flow in a particular way, rather than substantially preventing the flow. In these embodiments, means may be provided for preventing the valve member from creating a complete liquid impermeable seal with the valve seat when it moves into the closed position. One possible means might be to provide one or more indents or the like in the surface of the valve member or in the valve seat, or both, such that when the valve member moves into the closed position, the indents prevent a liquid impermeable seal from being created between the valve member and the valve seat in the vicinity of the indents. In other words, even when the valve is moved into the closed position to close the valve, a limited amount of water may be able to flow between the valve member and the valve seat in the vicinity of the indents (typically through the gaps created by the indents).

Another way of configuring the valve to merely restrict the liquid to flow in a particular way would be to provide a gap, opening, passage or something similar in the valve member through which liquid can flow to at least some extent when the valve is closed. Hence, liquid would be able flow through the gap, opening etc in the valve member, and hence through the valve, even when the valve member engages with the valve seat to prevent or limit flow between the valve member and the valve seat.

Other means may also be used for allowing a limited amount of water to pass through the valve even when the valve is closed. For example, means may be provided for preventing the valve member from moving all the way (or fully) into the closed position, and hence prevent a liquid impermeable seal from being fully formed between the valve member and the valve seat. This means (which is discussed below) might also be adjustable so as to adjust the amount of water that can flow through the valve when the valve is closed. One reason why it might be desired to allow a limited amount of water to pass through the valve even when the valve is closed is to prevent the hygroscopic materials from drying out (and hence prevent the valve from being allowed to open) prematurely. In other words, in some cases it may be desirable to allow a small flow of water through the valve while the valve is closed in order to maintain the hygroscopic material in the wet swollen or expanded state. This could be done to help prevent the valve from opening up at times when it is still desired to keep the valve closed to prevent the majority of water in the vessel/conduit from escaping through the valve.

The valve incorporates a hygroscopic material that can move the valve member between the open and closed positions. As noted above, in general, a hygroscopic material is a material that can take up water through either absorption or adsorption. The present invention utilises the ability of hygroscopic materials to absorb water. In particular, the present invention utilises hygroscopic materials which swell and increase in size and volume when they absorb water. A range of hygroscopic materials having this property may be used for this purpose. One material that has been found to perform particularly well is cellulose, and in particular fibrous cellulose which can absorb water and swell to up to or over two times its dry size.

As explained above, when the valve member is in the open position, water is able to pass freely through the valve. However, as the water passes through the valve the hygroscopic material absorbs some of the water causing the hygroscopic material to swell and expand. When the hygroscopic material expands, it pushes (or pulls) on the valve member causing the valve member to move from the open position to the closed position. The hygroscopic material may engage directly with the valve member so that it pushes (or pulls) directly on the valve member as it expands. Alternatively, one or more intermediate components may be interposed between the hygroscopic material and the valve member such that the hygroscopic material indirectly pushes (or pulls) the valve member as it expands. In other words, the hygroscopic material may push (or pull) on the intermediate component(s) as it expands, and the intermediate component(s) may in turn push (or pull) on the valve member.

In other embodiments, the valve may be closed when the hygroscopic material is dry, and wetting the material (making it swell) may cause the hygroscopic material to push (or pull) the valve member into the open position to open the valve.

In preferred embodiments, an intermediate component may be provided in the form of a substantially rigid cap extending over the hygroscopic material between the hygroscopic material and the valve member, and also extending around the sides of the hygroscopic material. By extending around the sides of the hygroscopic material, the rigid cap may help to constrict the hygroscopic material from expanding in a direction that does not move the valve member. Rather, the valve may be one where wetting the hygroscopic material closes the valve and the cap may help to ensure that the hygroscopic material expands at least mostly in the direction that pushes (or pulls) the valve member into the closed position.

The valve may also be provided with means for varying the rate at which the valve closes. One of the ways in which this might be achieved is by varying the amount of water that comes into contact with the hygroscopic material as the water passes through the valve. In other words, by varying the proportion of the water passing through the valve that comes into contact with and is absorbed by the hygroscopic material. In some embodiments, the cap mentioned in the previous paragraph may be provided with one or more cutouts to allow water to penetrate through the cap to be absorbed by the hygroscopic material. The number and size of the cutouts may be varied to adjust the rate at which water comes into contact with the hygroscopic material as it flows through the valve. This may in turn vary the rate at which the hygroscopic material expands, thereby varying the rate at which the valve closes. In other words, altering the number and/or size of the cutouts in the cap may be used to vary the amount of water that must flow through the valve in order to move the valve member from the open position to the closed position. Another way of varying the rate at which the valve closes may be to provide the cap with at least one adjustable portion to adjust the amount of hygroscopic material that is directly exposed to the liquid. The adjustable portion could comprise a sliding sleeve that could slide one way to expose more of the hygroscopic material and the other way to expose less. Other means could also be used. It will be appreciated that portions of the hygroscopic material which are not directly exposed to the liquid may still absorb moisture and swell, for instance by absorbing liquid via capillary action from portions that are directly exposed to the liquid. However, swelling brought about in this way may be much slower than swelling caused by exposing the material to liquid directly. Hence, adjusting the amount of hygroscopic material that is directly exposed to the liquid may vary the closing rate (or possibly the opening rate) of the valve. These are just examples, and other means for varying the rate at which the valve closes may be used.

The valve may also incorporate one or more components whose purpose is to hold the valve seat, the valve member and the hygroscopic material (and also the cap if present) together. In some embodiments, this function may be performed by a thin elongate rod extending through the valve along the longitudinal axis of the valve. The rod may attach at one end to the valve seat and at the other end to the hygroscopic material. The rod may also extend through the hygroscopic material and the valve member (and also the cap if present). In other words, the hygroscopic material, cap and valve member may be mounted to respectively expand and contract along the rod (in the case of the hygroscopic material) or move up and down along the rod (in the case of the valve member and the cap) as the valve opens and closes. Hence, the rod may help to maintain all the components of the valve together. It may also provide a guide to ensure that the hygroscopic material expands, and that the valve member moves, in the correct direction for proper opening and closing function of the valve. The rod may also incorporate a stop for limiting the movement of the valve member. This may be used to allow a limited amount of water to pass through the valve even when the valve is closed, by preventing the valve member from moving fully into the closed position as described above. The position of the stop may be adjustable to vary the amount of water that can pass through the valve when the valve is closed.

### BRIEF DESCRIPTION OF THE DRAWINGS

Certain embodiments and aspects of the invention are described below with reference to the drawings. However, it will be clearly appreciated that these embodiments and aspects are described for the purposes of illustration only and the invention is not necessarily limited to or by the particular features described. In the drawings:

FIG. 1 is a perspective illustration of a valve in accordance with one embodiment of the invention,

FIG. 2 is a side view of the valve of FIG. 1,

FIG. 3 is a top view of the valve of FIG. 1,

FIG. 4 is a bottom view of the valve of FIG. 1,

FIG. 5 is a cross-sectional side view of the valve of FIG. 1 along the line A-A in FIG. 2,

FIG. 6 is a close-up cross-sectional view of detail B from FIG. 5,

FIG. 7 is a side view of the valve of FIG. 1 showing the hygroscopic rings in a dry condition, and hence the valve ball in the open position,

FIG. 8 is a side view of the valve of FIG. 1 showing the hygroscopic rings in a partially wetted expanded condition, and hence the valve ball part way between the open position and the closed position,

FIG. 9 is a side view of the valve of FIG. 1 showing the hygroscopic rings in the saturated fully expanded condition, and hence the ball in the closed position,

FIG. 10 is a schematic illustration of a building roof plan used to explain one possible application of the valve,

FIG. 11 is a side view of a valve in accordance with another embodiment of the present invention,

FIG. 12 is a side view of a valve in accordance with yet another embodiment of the present invention,

FIG. 13a and FIG. 13b each show a partial side view of a valve in accordance with a further embodiment of the present invention having a sliding sleeve on the cap,

FIG. 14 illustrates different ways that liquid can flow over the cap,

FIG. 15 is a perspective view of valve in accordance with another embodiment of the present invention, and

FIGS. 16a and 16b illustrates water diverter in accordance with a variation on the invention.

### DETAILED DESCRIPTION OF THE DRAWINGS

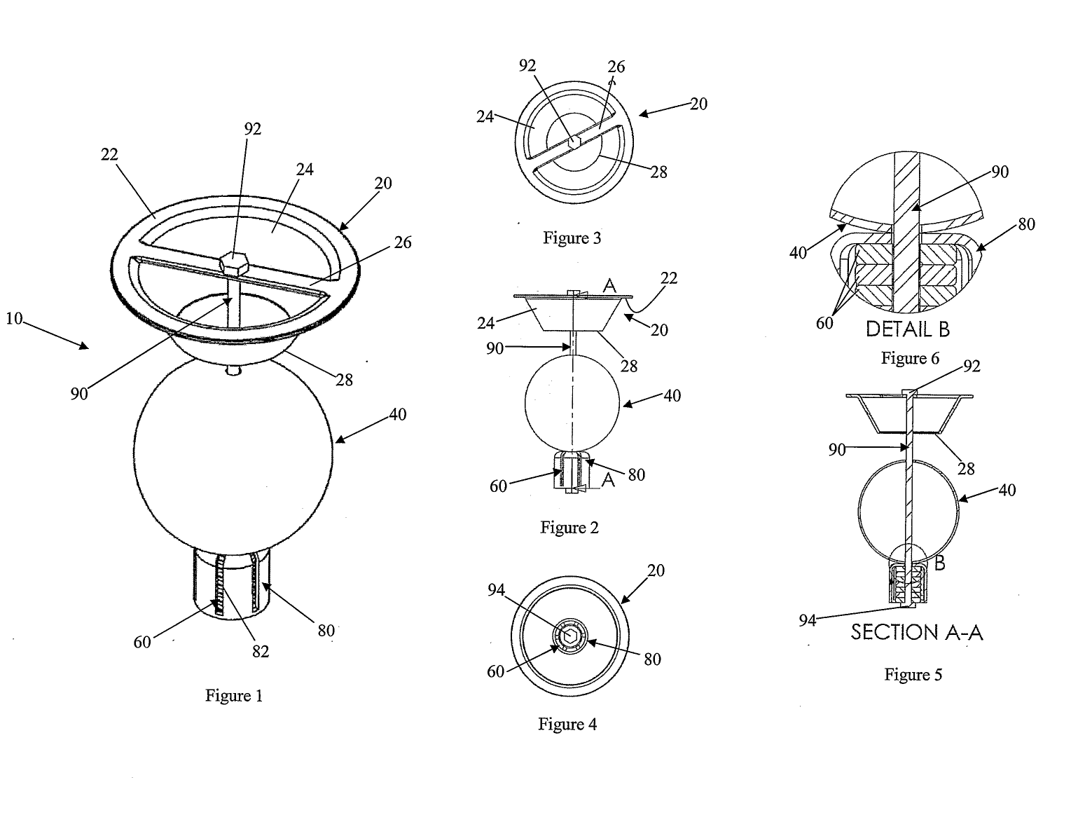

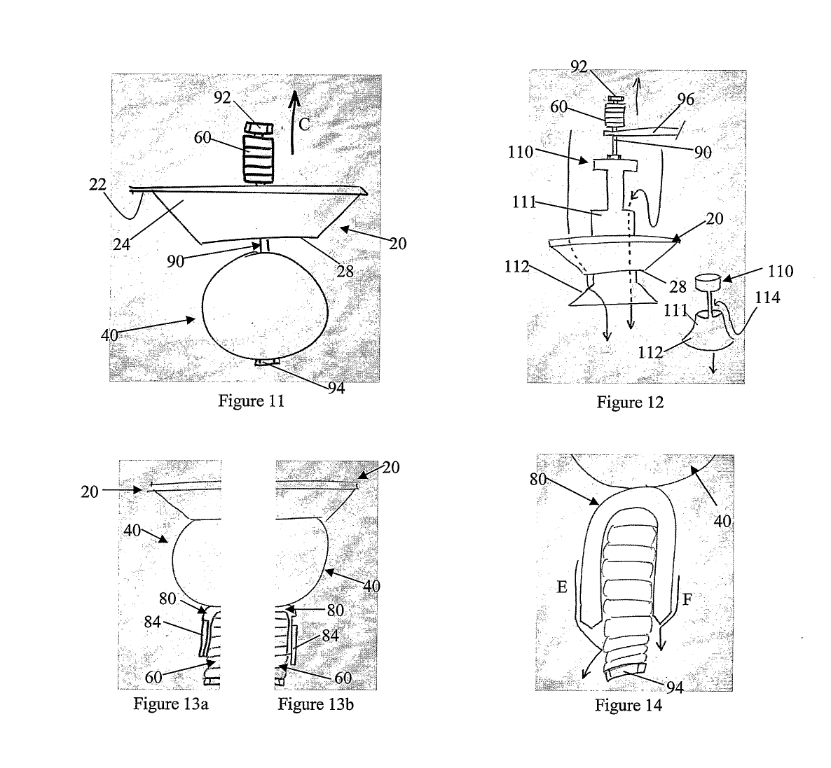

In FIG. 1, the valve is generally designated by reference numeral 10. Valve 10 comprises a valve seat 20, a valve ball 40, a series of expandable hygroscopic rings 60 (there are seven rings stacked on top of each other in this embodiment) and a cap 80. These components are all mounted on a thin rigid rod 90 which extends along the longitudinal axis of the valve. FIGS. 11-16b show different embodiments and aspects of the invention. Features shown in FIGS. 11-16b that are common with the embodiment shown in FIGS. 1-10 will be referred to using common reference numerals. Features in FIGS. 11-16b which are different to the features shown in FIGS. 1-10 will be referred to using different reference numerals.

The valve seat 20 in the embodiment in FIGS. 1-10 is a generally circular component. Therefore, in this embodiment the valve is adapted to be inserted into an opening in a water flow conduit or a water storage vessel that has a similar circular shape to the valve seat 20. The valve seat 20 comprises a peripheral lip 22 which extends around the entire circumference of the seat, and a downwardly converging conical wall 24. The valve seat is designed to be inserted into a circular opening in a water conduit/vessel having a diameter slightly greater than the maximum diameter of wall 24, but smaller than the outer diameter of lip 22. Therefore, when the valve seat 20 is inserted into the circular opening in the vessel/conduit, the underside of lip 22 overlaps with and mates against the edge of the conduit/vessel. Mechanical fasteners (not shown) can then be inserted through the overlapping lip 22 and the edge of the opening to secure the valve seat 20 (and hence the valve 10) in position. Alternatively, adhesives (not shown) may be inserted between the underside of lip 22 and the edge of the opening to secure the seat 20 in position.

The valve seat 20 also has a cross member 26 extending across its diameter. The rod 90 is attached through a small hole (not visible) in the middle of cross member 26. A small hexagonal nut member 92 on the upper end of rod 90 secures the rod in position and prevents the rod from pulling through the hole in the cross member 26. The rod 90 operates to secure the components of the valve together, and to provide a guide for the moving components of the valve, as described further below.

The conical wall 24 of the valve seat 20 defines a passageway extending all the way through the seat. Hence, when the valve is open, water is able to flow through the passageway. The narrow lower end of the wall 24 forms a circular rim 28. The circular rim 28 receives the smooth spherical outer surface of the ball 40 when the valve closes.

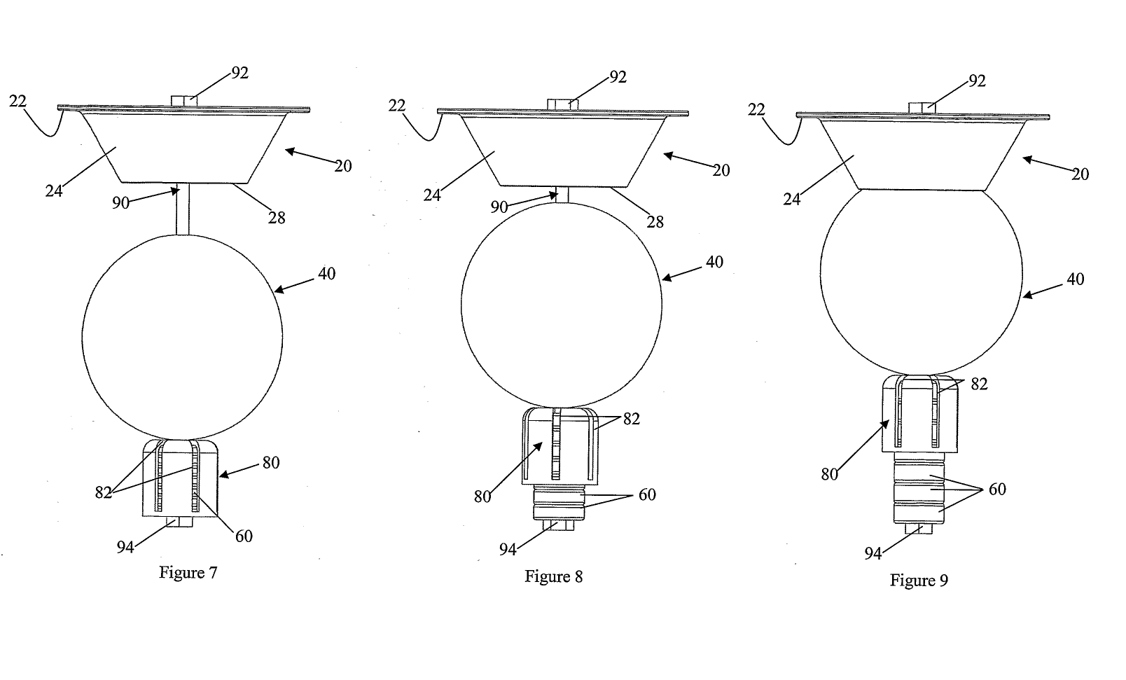

The cap 80 is a generally cylindrical component. The upper end of the cap is closed over to cover the top of the hygroscopic rings 60, except for a small hole therein (not visible) to allow the rod 90 to pass through. The top and sides of the cap 80 have a number of longitudinally extending cutouts 82 therein. The purpose of the cutouts 82 is to allow water that enters the valve through the seat 20 to come into contact with the hygroscopic rings 60, even when the rings 60 are initially dry and therefore contained almost entirely within the cap 80 (as shown in FIG. 7). Those skilled in the art will appreciate that the size and number of cutouts 82 may be varied in order to vary the rate at which water entering the valve comes into contact with the hygroscopic rings 60. Therefore, the size and number of the cutouts may be varied in order to vary the closing rate of the valve. The way the sides of the cap 80 extend down around the sides of the hygroscopic rings 60 helps prevent the rings from expanding outwardly. Instead, the sides of the cap 80 constrict the rings to expand longitudinally so as to move the ball 40 as described below.

Finally, the hygroscopic rings 60 comprise a series of disk like components mounted one on top of the other on the lower end of rod 90. The rings 60 are made from hygroscopic fibrous cellulose and are held on the lower end of the rod by a hexagonal nut member 94.

The operation of the valve can be conveniently explained with reference to FIGS. 7-9. FIG. 7 shows the valve with the ball 40 in the open position. In the open position, the ball 40 is located towards the lower end of the valve meaning that it does not engage with the circular rim 28 of the valve seat. Also, the hygroscopic rings 60 are in their dry unexpanded state. However, when water begins to flow through the passageway in valve seat 20, the water will flow over the ball 40 and some of the water will penetrate through the cutouts 82 in the cap 80 to come into contact with the hygroscopic rings 60. At least some of the water that comes into contact with the hygroscopic rings 60 will be absorbed causing the hygroscopic rings to expand as shown in FIG. 8. The expansion of the hygroscopic rings pushes upwardly on the cap 80 forcing it to slide up the rod 90. This in turn pushes the ball 40 up the rod. As water continues to flow through the valve seat, the hygroscopic rings 60 will absorb more and more water causing them to expand further and push the cap 80 and ball 40 further up the rod 90. This continues until the ball 40 reaches the position shown in FIG. 9. FIG. 9 shows the ball in the closed position where the spherical surface of the ball is pushed into close sealing engagement with the lower rim 28 of the valve seat. The engagement of the ball with the valve seat closes the valve and prevents substantially any water from flowing through the valve.

Although not shown in the drawings, some embodiments of the invention may have small intents in the surface of the ball 40 which create small caps between the ball 40 and the circular rim 28 of the valve seat when the ball reaches the closed position. These gaps may allow small amounts of water to continue to flow through the valve even when the ball 40 is in the closed position. This may help to maintain the valve closed by ensuring a continued small flow of water to keep the hygroscopic rings 60 wet and expanded. Alternatively, the rod 90 may be provided with a stop to keep the ball 40 from moving fully into the closed position. The position of the stop along the rod 90 may be adjustable to adjust how far the ball 40 is kept from the closed position, and hence adjust the amount of water that can pass through the valve when the valve is closed. Again, the stop is not shown in the drawings.

Returning to the drawings, the valve will remain closed as shown in FIG. 9 until the hygroscopic rings 60 begin to dry out whereupon they will begin to shrink. This allows the ball to move back down the rod under the influence of gravity until it reaches the fully open position shown in FIG. 7. In some situations, the valve of the present invention might be installed in a slightly different orientation, for example upside-down or horizontal. If this is the case, gravity may not help to move the ball 40 back down the rod 90 to open the valve. Therefore, a spring or other biasing means might be provided to return the ball 40 to the open position, although it will be appreciated that the stiffness of the biasing means should be sufficiently low so the expanding hygroscopic rings 60 can overcome the biasing force to push the ball 40 along the rod 90 into the closed position.

The valve of the present invention may be used to perform a similar function to existing first flush diverters. As explained above, first flush diverters operate on the basis that contaminants are deposited on the roof of a building during dry periods between episodes of rainfall. Therefore, the water collected from the roof during the initial period of rainfall after a dry spell contains a high concentration of contaminants. However, this initial period of rainfall effectively flushes the roof off and so, as it continues to rain, water collected from the roof after the initial period of rainfall is comparatively clean. Consequently, first flush diverters operate to divert the volume of water that runs off the roof during the initial period of rainfall (i.e. the initial flush of water containing the higher concentration of contaminants) away from the tank. The comparatively clean water that is collected from the roof after the initial period of rainfall is then directed into the tank for storage.

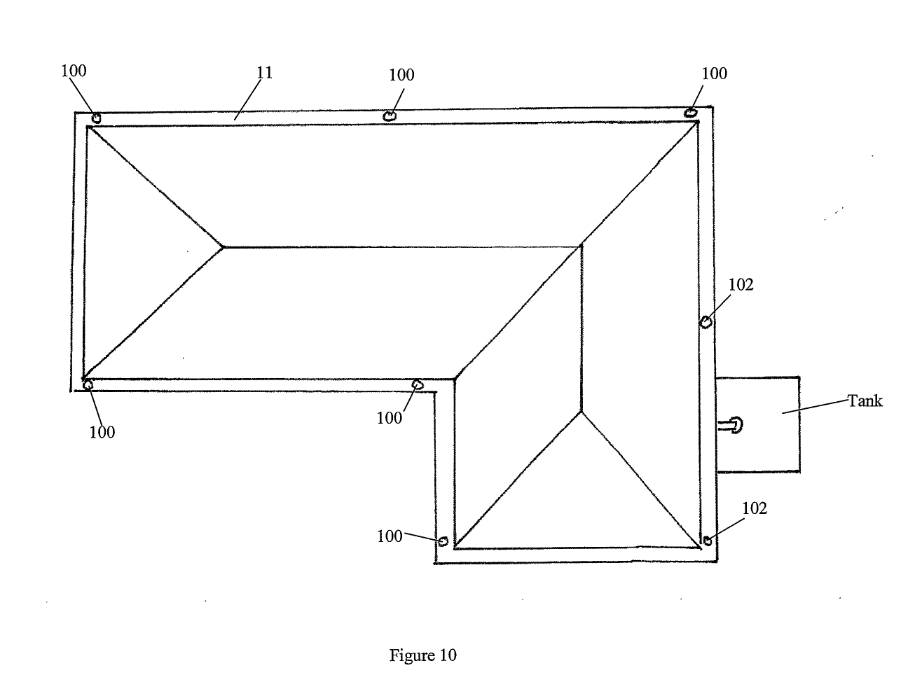

The valve of the present invention can be used to provide a simple yet effective first flush diverter. This can be conveniently explained with reference to FIG. 10. All that is required is for a valve 10 to be installed in the (or each) downpipe of a building roof that does not feed into the tank. In FIG. 10, the downpipes indicated by reference numeral 100 each contain a valve 10 and each lead away from the tank. Conversely, the downpipes indicated by reference numeral 102 do not contain a valve and feed into the tank.

During dry periods between episodes of rainfall (when the contaminants are collecting on the roof), the hygroscopic rings 60 of each valve 10 will dry out and contract. Hence, during these periods the valves will be open (as shown in FIG. 7). Also, the valves 10 will remain open (or at least partially open) during the initial period of rainfall after the dry spell because their hygroscopic rings 60 will not have expanded sufficiently to close the valves. Consequently, the contaminated water flowing off the roof during the initial period of rainfall can flow through the valves, and because the valves are installed in downpipes 100 which do not lead to the tank, the contaminated water passes down those downpipes away from the tank. However, after the initial period of rainfall, the hygroscopic rings 60 will have expanded sufficiently to close the valves 10 so that the clean water collected from the roof cannot run down the downpipes 100. Rather, the clean water is forced to continue to flow along the roof guttering 11 until it reaches one of the downpipes 102 which lead into the tank. The closing rate of the valves 10 may be varied as described above to ensure that the valves remain open for a sufficient time to allow the majority of the contaminants to be flushed from the roof, but not so long as to allow too much clean water to escape.

FIG. 11 illustrates another possible embodiment of the invention. The embodiment in FIG. 11 differs from the embodiment in FIGS. 1-10 primarily in that the hygroscopic rings 60 are positioned above the valve seat 20. More specifically, the hygroscopic rings 60 are mounted between the cross member 26 and the nut member 92 on the upper end of the rod. Consequently, in this embodiment of the invention, when the hygroscopic rings 60 become wet and expand, this expansion causes the hygroscopic rings to push upwardly on nut member 92 in the direction of arrow “C”. This causes rod 90 to move upwardly with respect to valve seat 20, which in turn pulls the valve ball 40 (which is held on the other end of the rod by nut member 94) upwards into sealing engagement with the valve seat.

FIGS. 13a and 13b show an embodiment which is generally similar to the embodiment in FIGS. 1-10, except that the cap 80 incorporates a sliding sleeve 84 instead of, or in addition to, the cutouts 82. The sliding sleeve 84 can be slid upwards relative to the rest of the cap 80 as shown in FIG. 13a. This exposes a greater proportion or area of the hygroscopic rings 60 and therefore increases the closing rate of the valve by increasing the rate at which liquid is absorbed by the rings. Conversely, the sliding sleeve 84 can be slid down relative to the rest of the cap as shown in FIG. 13b. This reduces the area or proportion of the hygroscopic rings 60 which is exposed and therefore slows the closing rate of the valve by reducing the rate at which liquid is absorbed by the rings.

Arrow “E” in FIG. 14 illustrates the flow of liquid through the valve and over the cap when the valve is initially open to allow liquid to pass. In contrast, arrow “F” illustrates the flow of water as the hygroscopic rings begin to dry out and the valve initially starts to open back up after being closed. Arrow “E” demonstrates that, when the valve is initially open, liquid can effectively “gush” through the valve, over 80, and into contact with hygroscopic rings 60. However, arrow “F” illustrates that the flow of water just as the valve ball 40 begins to move away from the seat 20 is little more than a trickle. This trickle tends to flow down over cap 80 (particularly if there are no cutouts 82 or if the sliding sleeve 84 is lowered), and the flow simply drips off the bottom edge of the cap without contacting much if at all with the hygroscopic rings 60. Consequently, even if a small amount of water is trapped in the valve seat 20 after an episode of rain etc, the flow pattern illustrated by arrow “F” allows the hygroscopic rings to dry out and contract (hence allowing the valve to open).

FIG. 12 illustrates another embodiment of the invention in which the valve member does not comprise a ball 40. Instead, the valve member comprises a hollow plug 110 extending through the opening in the valve seat 20. The plug 110 is supported on the lower end of rod 90, and the hygroscopic rings 60 are located between the nut member 92 on the top of the rod and a support member 96. Hence, wetting of the hygroscopic rings 60 pulls the plug 110 upwards to close the valve in a generally similar way to the embodiment in FIG. 11.

The plug 110 has a generally cylindrical portion 111 and an upwardly converging conical portion 112 located below cylindrical portion 111. The cylindrical portion 111 and the conical portion 112 have a bore communicating all the way therethrough between a pair of open slots 114 just above cylindrical portion 111 and an open base of the plug (not shown). Hence, even when the valve is closed, which brings the conical portion 112 of the plug into engagement with the valve seat rim 28 to form a seal that prevents flow between the plug and the seat, liquid is still able to pass through the valve by flowing into the slots 114 and through the bore in the plug. This is shown by the arrows in FIG. 12. Therefore the embodiment shown in FIG. 12 is one where closing the valve merely restricts the liquid to flow in a particular way rather than preventing flow all together.

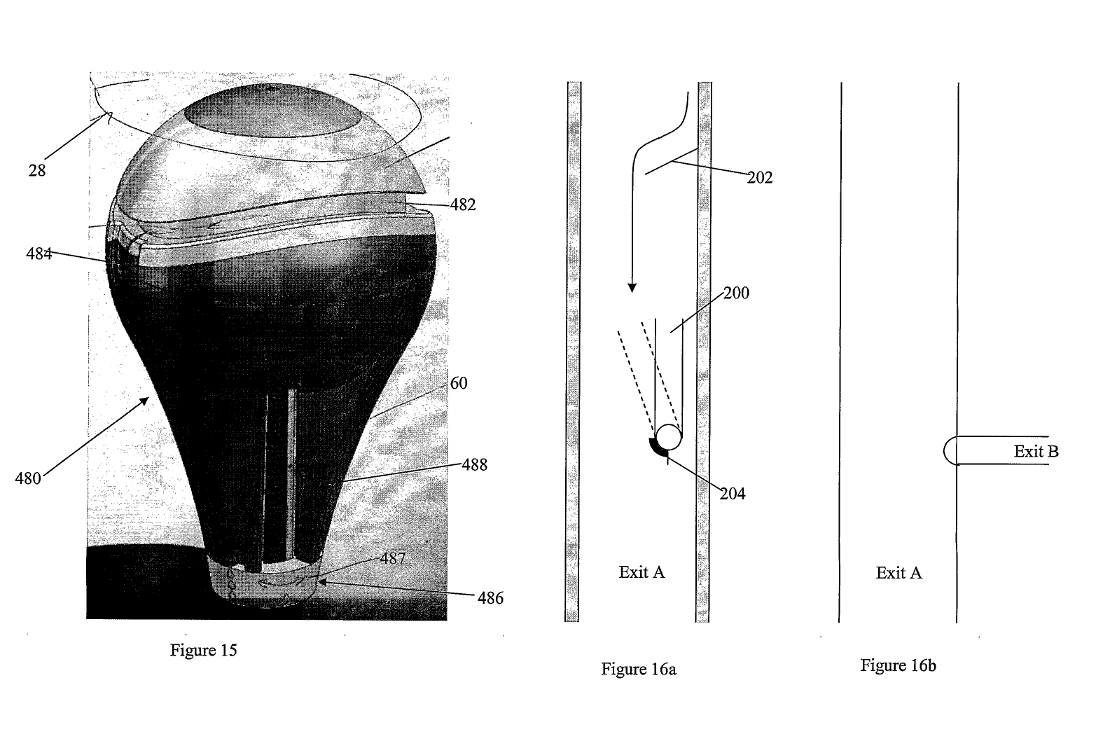

FIG. 15 illustrates another embodiment of the invention in which the valve ball 40 and the cap 80 from FIG. 1 have been replaced by a single roughly “lightbulb”-shaped component 480. The circle drawn above component 480 in FIG. 15 represents the lower circular rim 28 of the valve seat. Also, FIG. 15 shows that the hygroscopic rings 60 extend up through the centre of component 480. Consequently, the embodiment shown in FIG. 15 operates in generally the same way as the embodiment in FIG. 1 with the upper round portion of component 480 operating like the valve ball, and the lower conical portion of component 480 operating like the cap. The lighter shaded portion at the top of component 480 is made from silicon rubber which makes closely with the valve seat to form a seal.

The embodiment in FIG. 15 also incorporates additional features. For instance, there is a groove 482 extending circumferentially around the round upper portion of component 480. There is also a pair of channels 484 running down either side of the component. The groove 482 is curved slightly so that it slopes down to lower points where the groove 482 meets with the channels 484 on either side. The groove 482 and channels 484 operate to direct water way from the hygroscopic rings 60 when small amounts of water passed through the valve (i.e. amounts of water which are smaller than is desirably required to cause the valve to close). Hence, when a small flow of water passes through the valve seat it initially contacts with and flows over the round upper portion of component 480. The flow then enters groove 482. The sloping of groove 482 then directs the small flow of water down into the channels 484, and the small flow of water can therefore escape down the channels 484 without contacting the hygroscopic rings 60. Hence, small flows of water such as this do not cause the valve to close.

In contrast, when large flows of water passed through the valve seat, the flow will splash at over the groove 482 and flow down the side of the component 480 into contact with the hygroscopic rings 60 causing the valve to close.

The valve component 480 also incorporates an adjustable portion 486. FIG. 15 shows that adjustable portion 486 incorporates a grippable base portion 487 and a series of sleeve members 488 which extend up and partially around the hygroscopic rings 60. The adjustable portion 486 can be twisted relative to the rest of valve component 480. Twisting the adjustable portion 486 causes the sleeve members 488 to move around the hygroscopic rings 60. This has the effect of partially or fully covering up the hygroscopic rings, or alternatively exposing a greater area of the rings to thereby adjust the rate at which water can be absorbed and hence adjust the closing rate of the valve.

FIGS. 16a-16b relate to a form of flow diverter which is a variation on the invention. FIG. 16a is cross-sectional view through a vertical pipe which may be a rainwater downpipe or some other form of vertical conduit. FIG. 16b is an external side-on view of the same pipe/conduit. As these figures show, the pipe/conduit has two exits, namely Exit A and Exit B. The flow diverter operates to direct flow out through either Exit A or Exit B. From FIG. 16a can be seen that an upwardly oriented and tiltable tube 200 is positioned inside the pipe. The tube leads to Exit B so that any water which flows into the tube 200 flows out through Exit B. The tube 200 is positioned under a flow deflector 202 which deflects the flow entering the pipe as shown. A hygroscopic element 204 is also provided which functions to tilt the tube 200 from the position shown in dashed lines to the position shown in solid lines (or vice versa). Hence, in one version of this arrangement, water which enters the top of the pipe may initially be caught by the tube which is in the position shown in dashed outline, and is therefore diverted out Exit B. A small amount of the water may also spill over tube 200 to become absorbed by the hygroscopic element 204. As water is absorbed by the element, this may cause the tube 200 to tilt into the position shown in solid lines such that water entering the pipe is no longer caught in the tube and therefore exits the pipe via Exit A.

Those skilled in the art will recognize that various other changes and modifications can be made to the embodiments just described without departing from the spirit and scope of the invention.

We claim:

1. An in-line valve for closing or restricting flow through a liquid conduit or an opening in a liquid containment vessel when the valve is closed, the valve having a valve seat associated with the liquid conduit or the opening in the liquid containment vessel, a valve member that can move between an open position in which it does not engage with the seat and a closed position in which it engages with the seat to close the valve, and a hygroscopic material that can move the valve member between the open and closed positions, wherein when the valve member is in the open position liquid is able to pass freely through the valve but as the liquid passes through the valve the hygroscopic material absorbs liquid directly from the flow through the valve causing the hygroscopic material to swell and thereby move the valve member into the closed position restricting flow through the liquid conduit or the opening in the liquid containment vessel.

2. An in-line valve for closing or restricting flow through a liquid conduit or an opening in a liquid containment vessel when the valve is closed, the valve having a valve seat associated with the liquid conduit or the opening in the liquid containment vessel, a valve member that can move between an open position in which it does not engage with the seat and a closed position in which it engages with the seat to close the valve, and a hygroscopic material that can move the valve member between the open and closed positions, wherein the hygroscopic material absorbs liquid directly from the flow through the valve causing the hygroscopic material to swell and thereby move the valve member into the open position allowing liquid to pass freely through the valve, but as the hygroscopic material dries and contracts it moves the valve member into the closed position restricting flow through the liquid conduit or the opening in the liquid containment vessel.

3. An in-line valve as claimed in claim 1, wherein the valve seat comprises one or more components which are separate from the conduit or vessel, and the seat incorporates means for securing the seat in/to the conduit/vessel.

4. An in-line valve as claimed in claim 1, wherein the valve seat comprises a circular rim and the valve member is shaped to engage closely with the circular rim.

5. An in-line valve as claimed in claim 4, wherein the valve member or part thereof is shaped like a ball with a diameter considerably larger than that of the circular rim.

6. An in-line valve as claimed in claim 4, wherein the valve member or part thereof is shaped like a cone or truncated cone and is oriented with its converging end extending towards or into the valve seat.

7. (canceled)

8. An in-line valve as claimed in claim 1 wherein the hygroscopic material is fibrous cellulose.

9. An in-line valve as claimed in claim 1 having one or more intermediate components interposed between the hygroscopic material and the valve member such that the hygroscopic material indirectly pushes (or pulls) the valve member as it expands.

10. An in-line valve as claimed in claim 9, wherein an intermediate component comprises a rigid cap which extends around the hygroscopic material to confine the hygroscopic material to expanding, at least mostly, in the direction that pushes (or pulls) the valve member.

11. An in-line valve as claimed in, claim 1, wherein means are provided for varying the rate at which the valve closes.

12. An in-line valve as claimed in claim 11, having an intermediate component comprising a rigid cap which extends around the hygroscopic material to confine the hygroscopic material to expanding, at least mostly, in the direction that pushes (or pulls) the valve member, wherein the means for varying the rate at which the valve closes comprises one or more cutouts in the cap.

13. An in-line valve as claimed in claim 11, wherein the means comprises an adjustable portion associated with the valve member or the cap for adjusting the amount of hygroscopic material that is directly exposed to the flow of liquid.

14. An in-line valve as claimed in claim 13, wherein the adjustable portion comprises a sliding sleeve that slides one way to expose more of the hygroscopic material and the other way to expose less.

15. (canceled)
